(19) United States
(12) Patent Application Publication
(10) Pub. No.: US 2025/0033733 A1
(43) Pub. Date: Jan. 30, 2025

(54) VEHICLE STRUCTURE WITH LARGE STORAGE COMPARTMENT

(71) Applicant: GRANSTUDIO S.P.A., Torino (IT)

(72) Inventors: Lowie Vermeersch, Torino (IT); Goran Popovic, Torino (IT)

(73) Assignee: GRANSTUDIO S.P.A., Torino (IT)

(21) Appl. No.: 18/704,669

(22) PCT Filed: Oct. 25, 2022
(86) PCT No.: PCT/IB2022/060243

§ 371 Date: Apr. 25, 2024

(30) Foreign Application Priority Data
Oct. 27, 2021 (IT) 102021000027551

(51) Int. Cl. B62K 19/46; B62K 11/10

(52) U.S. Cl. CPC B62K 19/46; B62K 11/10; B62K 2204/00

(57) ABSTRACT

Electric vehicle structure (1) comprising at least two wheels (Ra, Rp), a frame (2) of the motorcycle type having a longitudinal axis (A) and a saddle (S) for a rider wherein a portion of the central frame (2b) is configured in a cradle-like fashion so as to house a container (7) for transporting luggage (B), objects or the like (C), designed so as to occupy, in an electric drive motor bike, substantially the space that would be occupied by the combustion engine in a combustion engine-driven motor bike.

### FIELD OF THE INVENTION

The present invention relates to a vehicle structure comprising a frame provided with a front steering fork and with at least one rear wheel driven by an electric motor. More particularly, the invention relates to a structure thus made provided with a storage compartment having a capacity such to make the vehicle a carrier means.

### STATE OF THE PRIOR ART

The market currently offers a wide range of two-wheeled vehicles provided with means for transporting small objects or luggage, for example using a rear carrier, side bags to be hooked to the frame, or a bag or a tank mesh provided with appropriate fixing means, for example magnetic or coupling means.

A problem common to such means for loading objects on motor bikes lies in the fact that they do not allow to transport neither bulky loads, due to their structural limitations nor heavy loads, due to the resulting displacement of the barycentre of the vehicle from its design position.

For example, an upward displacement of the barycentre due to a load arranged above the tank, further complicates the straightening of the motor bike, with the disadvantage of making the turning slower and more difficult for the rider. A backward movement of the barycentre for example due to a load arranged on a rear carrier, entails the drawback of reducing the ability of the motor bike to change direction, triggering hazardous oscillations of the front axle, especially at high speed.

The Chinese utility model CN212047723 U discloses an electric motor bike for transporting goods provided with a removable receptacle, for transporting objects, arranged substantially under the handlebar. A configuration thus made of the storage compartment entails the advancement of the barycentre which, for particularly heavy loads, has the drawback of making the vehicle unstable under braking, excessively loading the front suspension and determining potential lifting and skidding of the rear wheel.

DE 4201207 A1 Il relates to a vehicle frame comprising a pair of crossbars arcuated downwards which are joined at the front part and rear part. The two crossbars extend from the steering column with a downward arc, substantially up to the height of the hubs of the wheels of the vehicle in the median portion of the crossbars, and then with an upward arc up to the front portion of the saddle. Such configuration of the frame does not allow a lateral access thereinto, limiting the loading capacity and comfort thereof.

Therefore, there arises the need for a motor bike having a large loading capacity but which is capable, at the same time, of keeping the barycentre in the design position as much as possible, even for very heavy loads, so as to make the motor bike safe and easy to handle, and which is also easy to access so as to be able to insert and remove the luggage thereinto and therefrom easily and quickly.

### SUMMARY OF THE INVENTION

The object of the present invention is to overcome the aforementioned drawback.

With the aim of attaining such object, the invention relates to a vehicle structure comprising a frame having a longitudinal axis, a front frame portion carrying a fork which supports at least one front wheel steered through a handlebar, a rear frame portion bearing at the top a saddle and at the bottom at least one rear wheel driven by an electric motor, and a central frame portion, in which the central frame portion comprises a pair of lower crossbars which extend from a lower portion of the front frame up to a lower portion of the rear frame, and a pair of upper crossbars which extend from an upper portion of the front frame up to the front portion of the saddle, and wherein a median portion of the upper crossbars is spaced from a median portion of the lower crossbars by a distance equal to or greater than the larger dimension of a standard hand luggage.

The expression standard dimension of a hand luggage is used to indicate a suitcase measuring at least: larger dimension 55 cm, width 40 cm, thickness 25 cm.

Thanks to this solution idea, the particular shape of the frame of the vehicle structure according to the invention creates an empty space in the frame having a comfortable lateral access so as to insert large objects having a larger dimension measuring even 55 cm thereinto.

In a preferred embodiment of the invention, the vehicle structure further comprises a pair of front uprights and a pair of rear uprights which mutually connect the pairs of upper and lower crossbars, wherein a median portion of the front uprights is spaced from a median portion of the rear uprights by a distance equal to or greater than the larger dimension of a standard hand luggage so as to form—with the upper crossbars and the lower crossbars—a transportation container, the container being designed so as to occupy, in an electric drive motor bike, substantially the space that would be occupied by the combustion chamber in a combustion engine-driven motor bike.

In this manner, the vehicle structure according to the invention allows to transport large and heavy objects keeping the barycentre of the vehicle within the limits envisaged when designing, with the further advantage lying in the fact that the overall dimensions of the load do not protrude from the motor bike.

In a preferred embodiment of the invention, the median portions of the upper and lower crossbars and the median portions of the front and rear uprights extend for a length equal to or greater than the width of a standard hand luggage.

This allows to comfortably and quickly insert-from the lateral access of the vehicle structure according to the invention—a luggage having a width up to 55 cm or greater, and a width up to 40 cm or greater.

In a preferred embodiment of the invention, the lower crossbars extend substantially to the height of the hub of the front wheel, and the upper crossbars extend to a height greater than the saddle.

In a preferred embodiment of the invention, the electric motor is comprised in the hub of the rear wheel. This allows to fully vacate the container in the frame thus allowing to optimise the loading volume.

In a preferred embodiment of the invention, the vehicle structure comprises three or four wheels, in an embodiment both rear wheels are provided with a motor within each of the hubs.

In a preferred embodiment of the invention, the vehicle structure further comprises a storage compartment arranged above the luggage transportation container. Such compartment is configured so as to occupy, in an electric drive motor bike, substantially the space that would be occupied by the fuel tank in a combustion engine-driven motor bike.

In an embodiment according to the invention, the pair of lower crossbars is designed to house a battery pack for power-supplying the electric motor.

In a further embodiment, the luggage transportation container of the vehicle structure according to the invention is provided with at least one lateral access through an openable door, hinged to one of the front uprights so as to form a “book-like” opening system with substantially vertical axis.

In a different embodiment of the invention, the luggage transportation container is provided with lateral access through a hinged door so as to form a “book-like” opening system with horizontal axis and perpendicular to the longitudinal axis.

In a further embodiment, the storage compartment is provided with an upper access accesso through a door hinged to the front frame so as to form a “book-like” opening system with horizontal axis.

In an embodiment of the vehicle structure according to the invention, the luggage transportation container is shaped so as to house a luggage having the standard dimensions for the so-called hand luggage.

With reference to the standards of most aviation companies, the expression standard dimensions of a hand luggage is used to indicate a suitcase measuring about 55×40×25 cm.

In a further embodiment according to the invention, the storage compartment is shaped so as to house a helmet.

In a further embodiment, the vehicle structure according to the invention comprises a partitioning wall which separates the upper storage compartment from the lower transportation container. Such wall may be made of plastic and with a structure such to be able to be deformed so as to vary the volume of the compartment and of the container.

In this manner, when using the motor bike one can increase the volume of the lower transportation container deforming the partitioning wall upwards so as to allow to load large luggage, while when parking the motor bike, the partitioning wall can be deformed downwards so as to house—in the upper compartment—for example a helmet even a full-face helmet.

In an embodiment of the vehicle structure according to the invention, the lateral door of the transportation container is shaped like a fairing of the motor bike, and the door of the storage compartment is shaped like a tank of a motor bike.

In this manner, the vehicle structure according to the invention allows to provide a motor bike resembling a standard production motor bike provided with a fairing while maintaining a large loading capacity.

In an embodiment, the door of the transportation container is provided with a lower receptacle integrally joined therewith so as to house a lower portion of the luggage so as to simplify the insertion thereof into the transportation container.

In a further embodiment according to the invention, the openable door of the luggage transportation container has at least one opening protected by a net secured to a perimeter frame so as to allow to transport an animal.

In an embodiment, the transportation container comprises at least one adjustable band designed to secure the luggage within the container.

In a further embodiment, between the saddle and the rear frame there is provided for a housing designed to house a second battery pack so as to increase the durable operating time of the motor bike.

In an embodiment, the transportation container and the storage compartment are covered by a medium density foam so as to absorb any shocks and vibrations of the load which occur when using the vehicle.

### BRIEF DESCRIPTION OF THE DRAWINGS

The invention will now be described in detail with reference to the attached drawings, provided purely by way of non-limiting example, wherein:

FIG. 1 is a schematic perspective view of an embodiment of the vehicle structure according to the invention,

FIG. 2 is a side elevational view of FIG. 1,

FIG. 3 is a plan view of FIG. 1,

FIG. 4 is a schematic perspective view of a variant of FIG. 1,

FIG. 5 is a side elevational view of FIG. 4 which shows the upper storage compartment open,

FIG. 6 is a rear view of FIG. 4 which shows the lower transportation container open,

FIG. 7 is a schematic perspective view of FIG. 4 which shows a luggage secured to the transportation container,

FIGS. 8 to 12 are schematic perspective views of three different variants of the vehicle structure according to the invention,

FIGS. 13 and 14 are partially cross-sectional schematic perspective views of a further variant of the vehicle structure according to the invention in two different loading configurations,

FIG. 15 is a cross-sectional view of an in-wheel of a variant according to the invention,

FIG. 16 is a side elevational view of an embodiment of the vehicle structure according to the invention,

FIGS. 17 and 18 are schematic perspective views of two different variants of the vehicle structure according to the invention,

FIG. 19 is a plan view of a luggage which can be housed within the vehicle structure according to the invention.

### DETAILED DESCRIPTION OF THE INVENTION

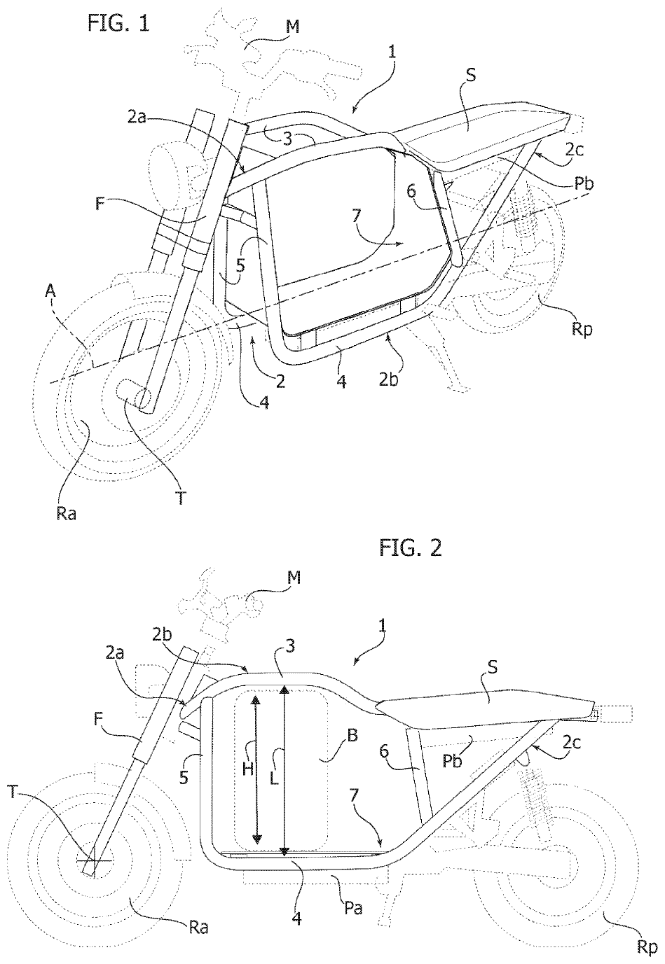

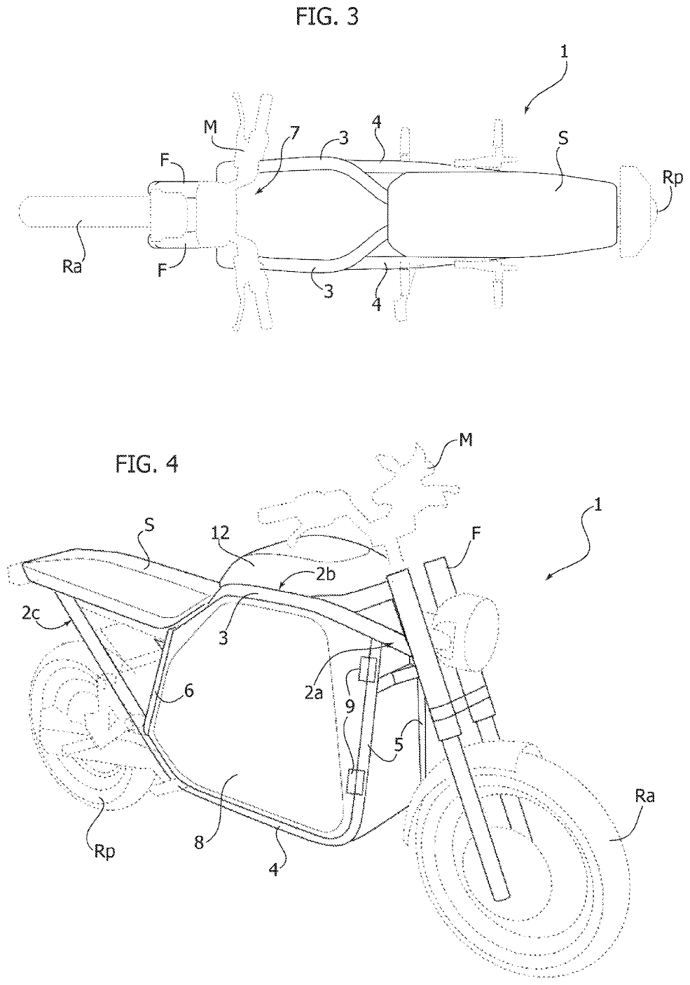

Initially with reference to FIG. 1, there is shown a first embodiment of the vehicle structure 1 according to the invention comprising two wheels Ra, Rp, a frame 2 of the motorcycle type having a longitudinal axis A and a saddle S for the rider.

The vehicle is generally of the conventional type and therefore only the essential components as well as those expressly referred to in the invention will be described.

A front frame portion 2a carries a fork F which supports the front wheel Ra steered through a handlebar M. A rear frame portion 2c carries—at the upper part—the saddle S and—at the lower part—the rear wheel Rp actuated by an electric motor, not shown given that it is generally known.

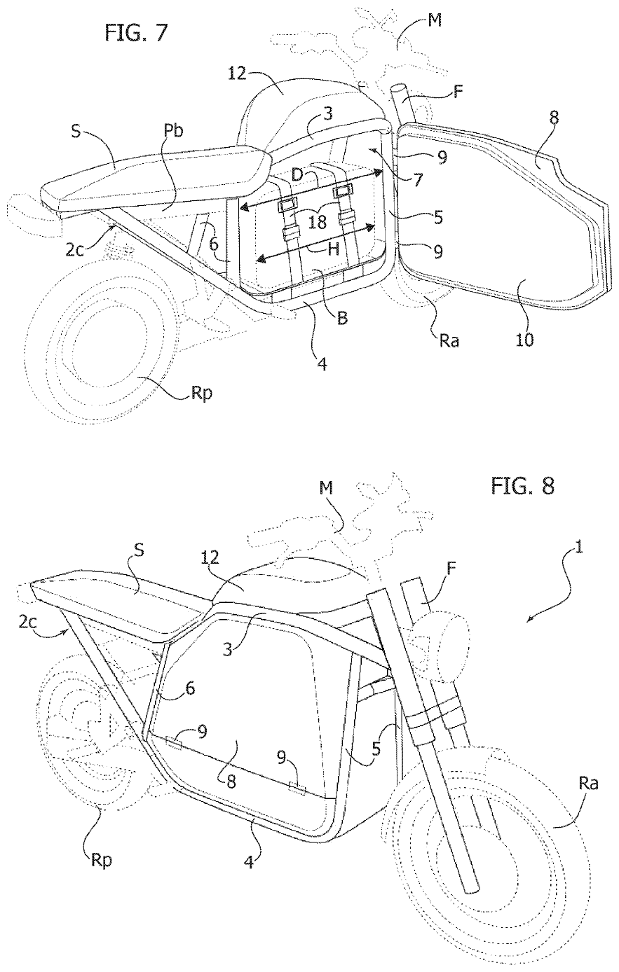

As observable in FIGS. 1 and 2 too, the central frame portion 2b comprises a pair of lower crossbars 4 which extend from a lower portion of the front frame 2a, substantially to the height of the hub T of the front wheel Ra, up to a lower portion of the rear frame 2c, and a pair of upper crossbars 3 which extend from an upper portion of the front frame 2a up to the front portion of the saddle S. Such upper crossbars 3 have an upward concave curvature so as to be spaced from the lower crossbars 4 by a height H typical of the dimensions of a standard hand luggage. The central frame portion 2b further comprises a pair of front uprights 5 and a pair of rear uprights 6 which mutually connect the pairs of upper 3 and lower 4 crossbars so as to form—therewith—the container 7 for transporting luggage, objects or the like, generally indicated with B in FIGS. 7, 11, 14, and with C in FIG. 12. The central frame portion 2b is therefore configured in a cradle-like fashion, so as to be able to house the container 7 which substantially occupies the space that would be occupied by the combustion engine in a combustion engine-driven motor bike.

Such arrangement of the frame 2 can for example be used to house-in the container 7—a typical hand luggage B, visible in FIG. 19, measuring: larger dimension 55 cm (H), width 40 cm (Z), thickness 25 cm. It should be observed that such shape of the frame allows to laterally access into the compartment allowing a comfortable lateral insertion of the luggage.

Conveniently, according to the invention, as observable in FIG. 2, the pair of lower crossbars 4 is further designed to house a battery pack Pa for power-supplying the electric motor. A further housing for a second battery pack Pb is instead obtained under the saddle S.

A first variant of the invention is shown in FIGS. 4 to 7 in which parts identical or similar to those described above are indicated using the same reference numerals.

In such embodiment of the vehicle structure 1 according to the invention, there is provided for a door 8, hinged to one of the front uprights 5 using a pair of hinges 9. Therefore, such door 8 can be opened by rotating it with respect to a substantially vertical, or slightly inclined, axis so as to be able to laterally access the transportation container 7 therefore allowing a comfortable access to the luggage B.

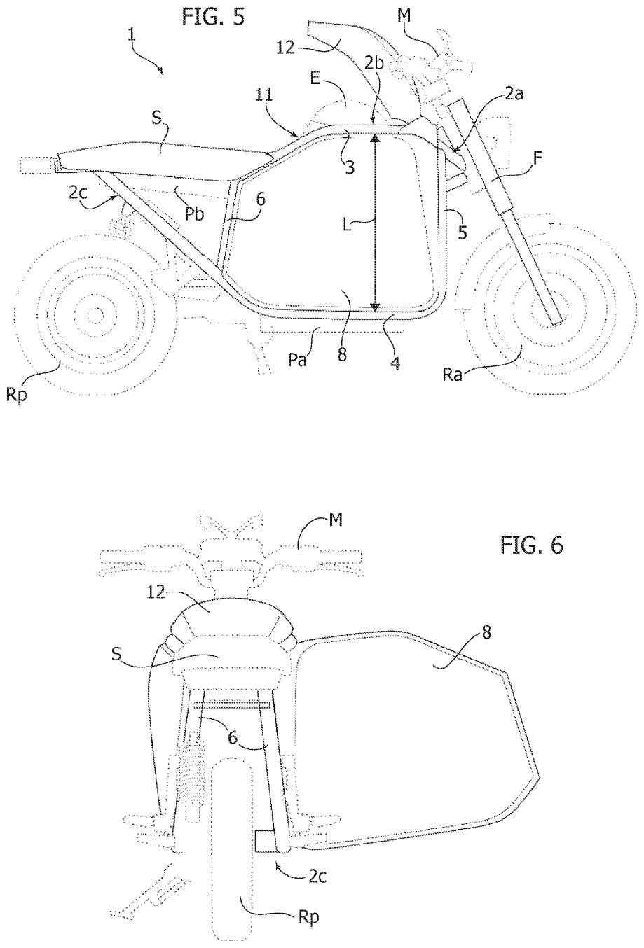

In such embodiment there is further provided for a storage compartment 11 arranged above the transportation container 7 and configured so as to house a conventional helmet E. As observable in FIG. 5, the compartment 11 occupies, in an electric drive motor bike, substantially the space that would have been occupied by the fuel tank in a combustion engine-driven motor bike. Such storage compartment 11 is provided with an upper access through a door 12 having the upper shape of a conventional tank; such door 12 is hinged to the front frame 2a so as to form a “book-like” opening system with horizontal axis.

As observable in FIG. 7, both the door 8 and the transportation container 7 may be covered by a coating made of soft material 10, for example a medium density foam, so as to absorb any shocks and vibrations of the load which occur when using the vehicle. Still in FIG. 7 there are also shown a pair of adjustable bands 18, designed to secure a luggage B within the container 7.

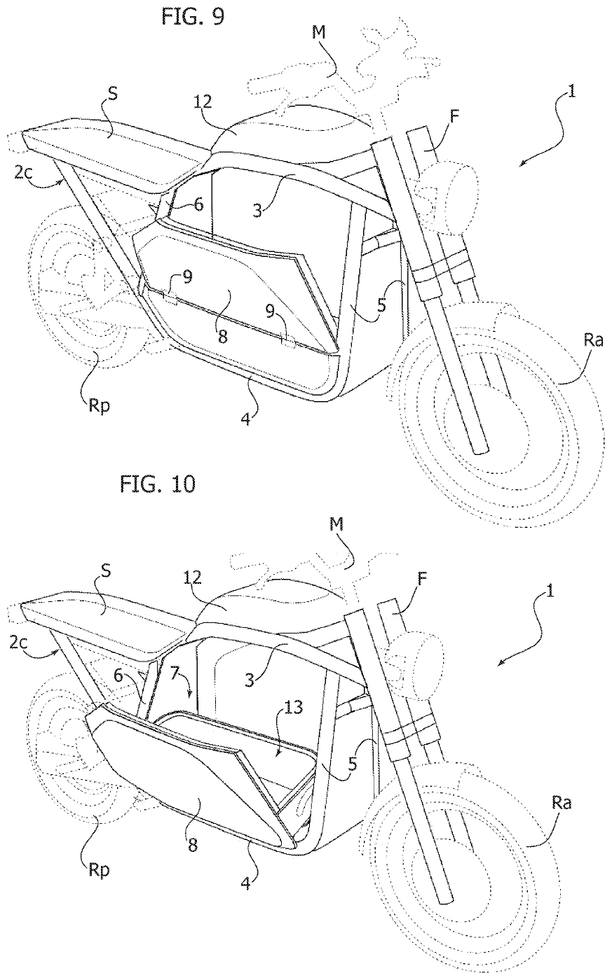

The variant of the invention shown in FIGS. 8 and 9 differs from the embodiment of FIG. 7 due to the fact that the door 8 is hinged in the lower end thereof, so as to form a “book-like” opening system with horizontal axis.

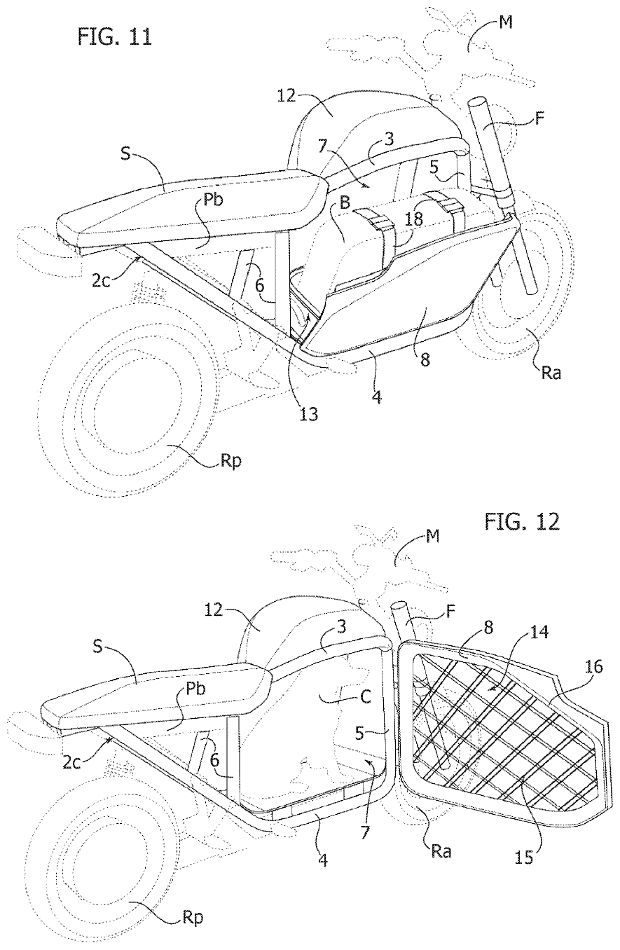

In the embodiment visible in FIGS. 10 and 11 there is also provided for a lower receptacle 13, integrally joined with the door 8, designed to house a lower portion of the luggage B so as to simplify the insertion thereof into the transportation container 7.

FIG. 11 shows a suitcase B loaded into such receptacle 13 and secured thereto using a pair of adjustable bands 18.

In the further embodiment of the vehicle structure 1 according to the invention shown in FIG. 12, the lateral door 8 has a circumferential opening 14, protected by a net 15 secured to a perimeter frame 16, so as to provide the required aeration so as to allow the transportation of an animal C, even of medium size.

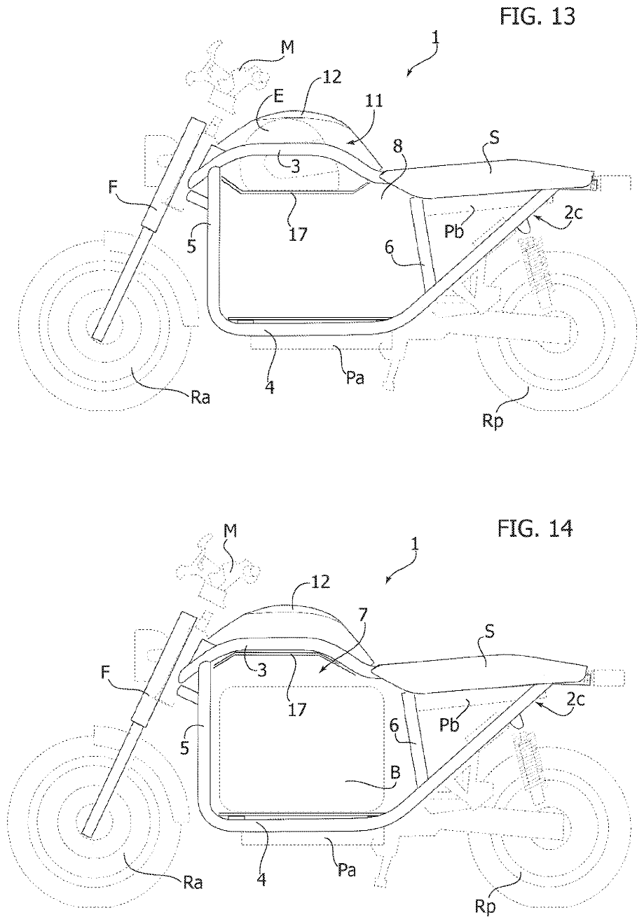

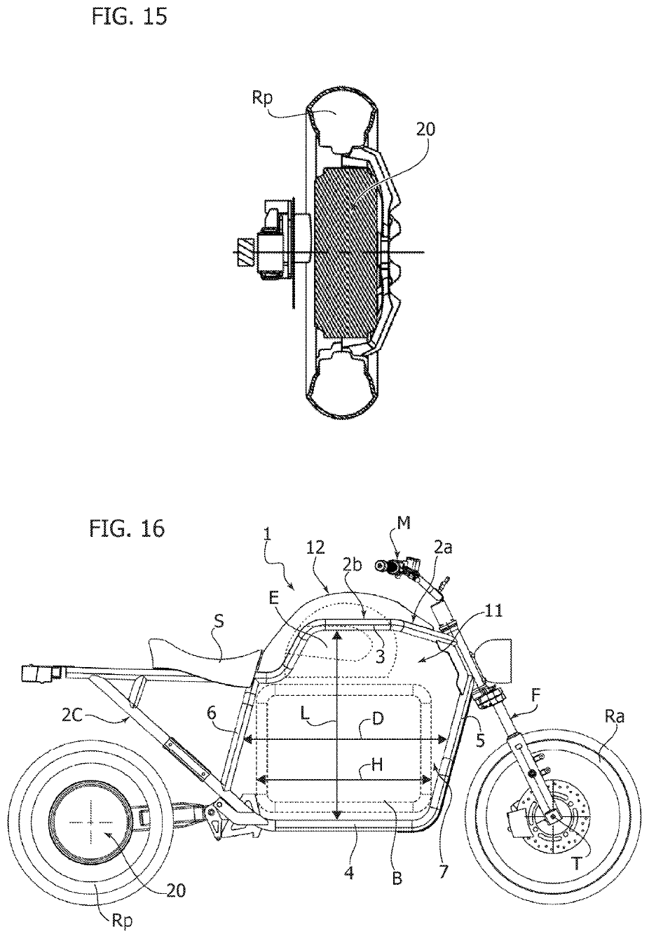

A further embodiment of the vehicle structure 1 according to the invention, in which a partitioning wall 17 separates the upper storage compartment 11 from the lower transportation container 7 is shown in FIGS. 13 and 14. Conveniently, according to an aspect of the invention, such wall 17 is made with a deformable plastic so as to allow to change the volumes of the upper compartment 11 and of the lower container 7. For example, this allows to increase the capacity of the lower container 7 when using the motor bike, so as to increase the available loading space, by deforming the wall 17 upwards. When the motor bike is not being used, the loading space of the upper compartment 11 can instead be increased by deforming the partitioning wall 17 downwards, so as to be able to comfortably insert a helmet E, even full-face helmet, thereinto.

In the variant of the invention shown in FIG. 16, the electric motor 20 is comprised in the hub of the rear wheel Rp which is a so-called in-wheel 20. Such positioning of the drive system allows to maximise the loading volume available in the frame 2.

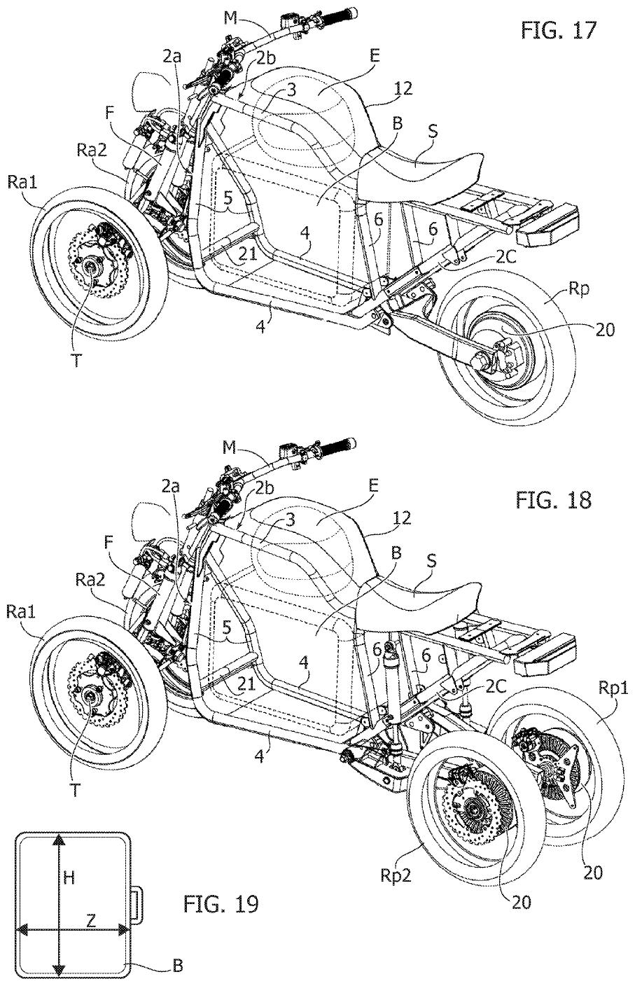

FIGS. 17 and 18 show two further variants according to the invention which respectively comprise a vehicle structure comprising two front wheels Ra1 and Ra2, and a vehicle structure which includes two front wheels Ra1 and Ra2 and two rear wheels Rp1 and Rp2. In the embodiment shown in the FIG. 18 both rear wheels Rp1 and Rp2 may be provided with an in-wheel 20.

Obviously, the construction details and the embodiments may widely vary with respect to what has been described and illustrated, without departing from the scope of protection of the present invention as defined in the claims that follow. Therefore, for example, the general shape of the fairing of the lateral door 8 and of the upper one 12 could be different from the one shown in the drawings, and be adapted to different types of motor bikes.

1. Vehicle structure comprising:
a frame having a longitudinal axis, a front frame portion bearing a fork which supports at least one front wheel steered through a handlebar, a rear frame portion bearing at the top a saddle and at the bottom at least one rear wheel driven by an electric motor, and a central frame portion,
wherein said central frame portion comprises a pair of lower crossbars which extend from a lower portion of said front frame up to a lower portion of said rear frame, and a pair of upper crossbars which extend from an upper portion of said front frame up to the front portion of said saddle, and
wherein a median portion of said upper crossbars is spaced from a median portion of said lower crossbars by a distance equal to or greater than the larger dimension of a standard hand luggage.

2. Vehicle structure according to claim 1,
wherein said central frame portion further comprises a pair of front uprights and a pair of rear uprights which mutually connect said pairs of upper and lower crossbars to each other,
wherein a median portion of said front uprights is spaced from a median portion of said rear uprights by a distance equal to or greater than the larger dimension of a standard hand luggage so as to form a transportation container with said upper crossbars and said lower crossbars, and
wherein said container being designed so as to occupy, in an electric drive motor bike, substantially the space that would be occupied by a combustion engine in a combustion engine-driven motor bike.

3. Vehicle structure according to claim 1, wherein said median portions of said upper and lower crossbars and said median portions of said front and rear uprights extend for a length equal to or greater than the width of a standard hand luggage.

4. Vehicle structure according to claim 1, wherein said lower crossbars extend substantially to the height of said hub of the front wheel, and said upper crossbars extend to a height greater than said saddle.

5. Vehicle structure according to claim 1, wherein said electric motor is comprised in the hub of said rear wheel.

6. Vehicle structure according to claim 1, wherein the vehicle structure comprises three or four wheels.

7. Vehicle structure according to claim 1, wherein the vehicle structure further comprises a storage compartment arranged above said transportation container and configured so as to occupy, in an electric drive motor bike, substantially the space that would be occupied by the fuel tank in a combustion engine-driven motor bike.

8. Vehicle structure according to claim 1, wherein said pair of lower crossbars is designed to house a battery pack for power-supplying said electric motor.

9. Vehicle structure according to claim 1, wherein said transportation container is provided with a lateral access through an openable door hinged to one of said front uprights so as to form a book-like opening system with a substantially vertical axis.

10. Vehicle structure according to claim 1, wherein said transportation container is provided with a lateral access through a door hinged so as to form a book-like opening system with a horizontal axis and perpendicular to said longitudinal axis.

11. Vehicle structure according to claim 1, wherein said storage compartment is provided with an upper access through a door hinged to said front frame so as to form a book-like opening system with a horizontal axis.

12. Vehicle structure according to claim 1, wherein said transportation container is shaped so as to house a luggage having the standard dimensions for the so-called hand luggage.

13. Vehicle structure according to claim 1, wherein said storage compartment is shaped so as to house a helmet.

14. Vehicle structure according to claim 1, wherein the vehicle structure comprises a partitioning wall which separates said upper storage compartment from said lower transportation container and in that said wall is deformable so as to vary the volume of said compartment and of said container.

15. Vehicle structure according to claim 1, wherein said lateral door of said transportation container is shaped like a fairing of said motor bike.

16. Vehicle structure according to claim 1, wherein said door of said storage compartment is shaped like a tank of said motor bike.

17. Vehicle structure according to claim 1, wherein said door of said transportation container is provided with a lower receptacle integrally joined therewith to house a portion of said luggage so as to simplify the insertion thereof into said transportation container.

18. Vehicle structure according to claim 1, wherein said door of said transportation container has at least one opening protected by a net so as to allow to transport an animal in said transportation container.

19. Vehicle structure according to claim 1, wherein said transportation container comprises at least one adjustable band designed to secure the luggage inside said container.

20. Vehicle structure according to claim 1, wherein a housing designed to house a further battery pack is provided for between said saddle and said rear frame.

21. Vehicle structure according to claim 1, wherein said transportation container and said storage compartment are covered by a medium density foam so as to absorb shocks and vibrations of the load which occur when using the vehicle.
